(19) United States
(12) Patent Application Publication
(10) Pub. No.: US 2020/0335052 A1
(43) Pub. Date: Oct. 22, 2020

(54) REDUCING IMAGE RETENTION IN DISPLAYS

(71) Applicant: Hewlett-Packard Development Company, L.P., Spring, TX (US)

(72) Inventors: Tim Guynes, Spring, TX (US); John W. Frederick, Spring, TX (US); Syed S. Azam, Spring, TX (US); Irene Chou, San Diego, CA (US)

(73) Assignee: Hewlett-Packard Development Company, L.P., Spring, TX (US)

(21) Appl. No.: 16/648,679

(22) PCT Filed: Jan. 11, 2018
(86) PCT No.: PCT/US2018/013410

§ 371 Date: Mar. 19, 2020

(51) Int. Cl. G09G 3/36; G09G 3/34

(52) U.S. Cl. CPC G09G 3/3614; G09G 3/3406; G09G 2320/046; G09G 2320/0257; G09G 3/3648

(57) ABSTRACT

A display is disclosed. The display includes a screen, a backlight to illuminate the screen, and an image retention reducer. The image retention reducer includes a driver to apply an image retention reduction pattern to the screen while the backlight is deactivated.

### BACKGROUND

A liquid-crystal display (LCD) is a flat-panel display or other electronically modulated optical device that uses the light-modulating properties of liquid crystals. Liquid crystals do not emit light directly. They use a backlight or reflector to produce images in color or monochrome. A plasma display panel (PDP) is a type of flat panel display common to large TV displays 30 inches (76 cm) or larger. They are called “plasma” displays because they use small cells containing electrically charged ionized gases, which are plasmas.

### BRIEF DESCRIPTION OF THE DRAWINGS

FIG. 1A is a schematic illustration of an example operating environment of a screen conditioner.

FIG. 1B is a schematic illustration of an example display.

FIG. 2 shows an example on-screen display (OSD).

FIG. 3 shows additional features of the on-screen display of FIG. 2.

FIG. 4 shows additional features of the on-screen display of FIG. 2.

FIG. 5 shows additional features of the on-screen display of FIG. 2.

FIG. 6 shows components of the screen conditioner according to one example.

FIG. 7 is a flowchart of a method to reduce image retention according to one example.

FIG. 8 is a block diagram of an example processor platform of an example screen conditioner.

The figures are not to scale. Wherever possible, the same reference numbers will be used throughout the drawing(s) and accompanying written description to refer to the same or like parts.

### DETAILED DESCRIPTION

Image persistence, or image retention, is the LCD and plasma display equivalent of screen burn. Unlike screen burn, however, the effects are usually temporary. For example, when a display is on for an extended period of time, liquid crystals can develop a tendency to stay in one position. In some examples, the applied voltages across certain panel pixels/cells related to a static (non-moving) image does not want to reset or release the current state of the liquid crystal (LC) material in the cells (e.g., image sticking, image retention, etc.). When the liquid crystals are in one position for too long, a requested color of the display can be altered slightly. For example, media is presented on the display for an extended period of time and one section of the display does not change (e.g., a logo for a television program). As such, image persistence or image sticking may occur (e.g., continue presenting the colors of the logo). Image persistence can be reversed by forcing the monitor to display a range of colors, or leaving an all-white image on the screen (e.g., screen conditioning). For example, while screen conditioning, a display may cycle through the range of red, green and blue colors to correct the image persistence. In other examples, the display may be turned-off for an extended period of time. In some examples disclosed herein, “pixel exercising,” a screen conditioning technique, is performed by turning pixels (e.g., liquid crystals) on, off, switching multiple colors, cycling cell brightness, etc. to offset, reduce or release a voltage potential across stuck cells to free up liquid crystal material.

In examples disclosed herein, built-in methods of using screen pattern and backlight manipulation to reduce LCD image retention issues are being used. In some examples, methods involve offering a built-in monitor timer that allows users to set on/off times for executing screen conditioning patterns while the monitor is on, to execute multiple, different screen conditioning patterns consecutively, and to interrupt a screen conditioning pattern after the timer has started. Screen conditioning patterns can reverse image persistence by forcing a monitor to display geometric patterns in a range of colors, or by leaving an all-white image on the screen. A user controlled resume time allows for real-time activation of the conditioning patterns when the monitor detects an inactive input signal from the source. Because liquid crystals do not produce light themselves, a backlight is utilized to illuminate the liquid crystals so they are visible. For example, during normal operation of an LCD display (e.g., a monitor screen), the backlight is on to illuminate the liquid crystals. As such, any image persistence would be visible to a user. Examples disclosed herein allow the screen conditioning patterns to execute while the monitor screen appears off. For example, the example screen conditioning techniques disclosed herein may be performed without the backlight so the liquid crystals are not illuminated.

Cheaper production costs of some LCD panels lead to adverse side effects, including designs that allow for longer than expected image retention or image burn issues. To reduce image retention issues in displays, an OSD (On-Screen Display) provides customer friendly options that can speed up or reduce image retention issues with LCD panels.

In some examples, LCD conditioner type solutions for TVs and monitors execute the screen conditioning patterns immediately for a set period of time and then exit. In some examples, daily or weekly schedule or real-time activation options are provided. For example, a daily timer can be set to perform screen conditioning during a specified period of time. Alternatively, whenever a screen saver is activated (e.g., no activity for a period of time), screen conditioning may be initiated to mitigate image retention. In some examples, LCD conditioning solutions execute while the screen is lit (e.g., with backlights on).

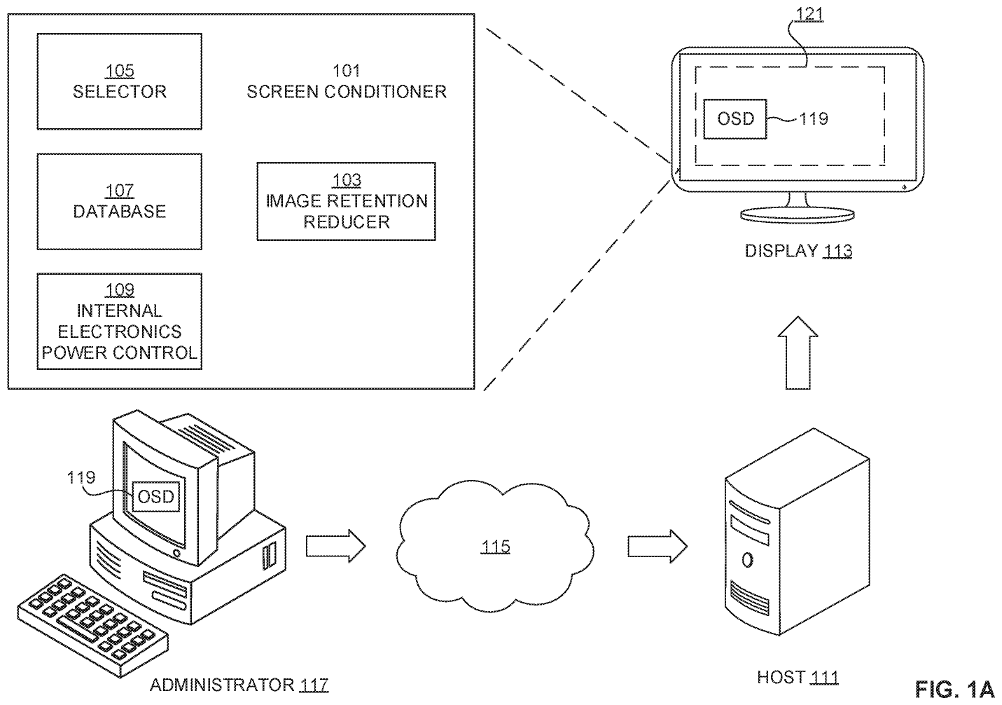

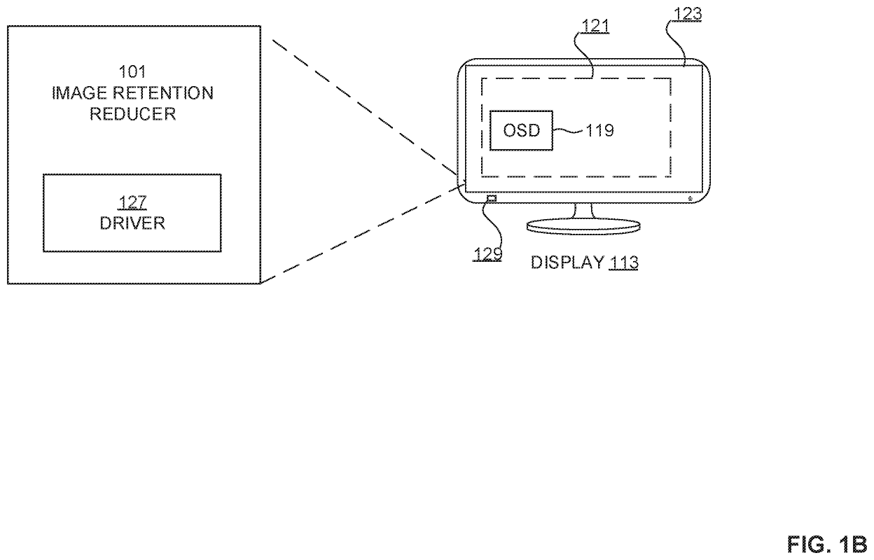

FIG. 1A is a schematic illustration of an example operating environment of a screen conditioner. FIG. 1A shows a screen conditioner 101, an image retention reducer 103, a selector 105, a database 107, an internal electronics power control 109, a host 111, a display 113, a network 115, an administrator 117, an on-screen display (OSD) 119 and backlight 121.

Referring to FIG. 1A, the screen conditioner 101 enables the selection of image retention reduction options from the database 107 that are applied to the display 113 for image retention reduction. FIG. 1B shows components of the display 113. The example display 113 may be a liquid-crystal display (LCD) display, an in-plane switching (IPS) display, a vertically aligned (VA) display, or any other type of display. The components of the display 113 can include but are not limited to a screen 123, the backlight 121 to illuminate the screen 123, and the image reducer 103 that includes a driver 127 to apply an image retention reduction pattern to the screen 123 while the backlight 121 is deactivated. In some examples, the screen 123 includes a plurality of pixels. In some examples, the display 113 includes a scaler 129 that detects pixel color respectively retained in corresponding ones of the pixels. In some examples, the driver 127 can activate the pixels to display colors opposite to the corresponding color retained in the respective pixels. The example driver 127 may perform screen conditioning techniques disclosed herein. For example, the scaler 129 may detect an area of the screen 123 that is retaining pixel color (e.g., image retention). As such, the driver 127 may turn off the backlight 121 and perform one or more screen conditioning techniques disclosed herein. Alternatively, the driver 127 may perform a screen conditioning technique disclosed herein only at the area of the screen 123 retaining the image identified by the scaler 129, for example.

Referring again to FIG. 1A, in some examples, the screen conditioner 101 can reside in the display 113. In other examples, the screen conditioner 101 can reside on host 111. In one example, the screen conditioner 101 includes the image retention reducer 103, the selector 105, the database 107 and the internal electronics power control 109.

The image retention reducer 103 accesses screen conditioner options from database 107 and applies the screen conditioner options to the display 113 for reducing image retention on the display 113. The screen conditioner options are described in detail herein below.

The database 107 stores screen conditioner options that image retention reducer 103 can access and apply to the display 113 for reducing image retention on the display 113.

The internal electronics power control 109, responsive to a user or administrator 117 selection of screen conditioning modes, causes the reduction/elimination of power to internal electronics. For example, a user or administrator 117 can indicate that screen conditioning is to be performed in a low power mode. In such mode, internal electronics power control 109 can cause the power to the internal electronics that are not necessary to operate in the low power mode to be shut off. For example, the internal electronics power control 109 may turn off a power LED, internal USB hub, webcam, speakers, ambient light sensor, and/or USB hubs and associated devices (e.g., webcam, microphone, touchscreen functions, USB audio, card readers, etc.).

The administrator 117 can remotely ensure that image retention reduction processes for computers that are a part of a network are performed. The administrator can access the screen conditioner 101 over the network 115 via the OSD 119 which enables the administrator to select screen conditioning options of the screen conditioner 101 as is described herein.

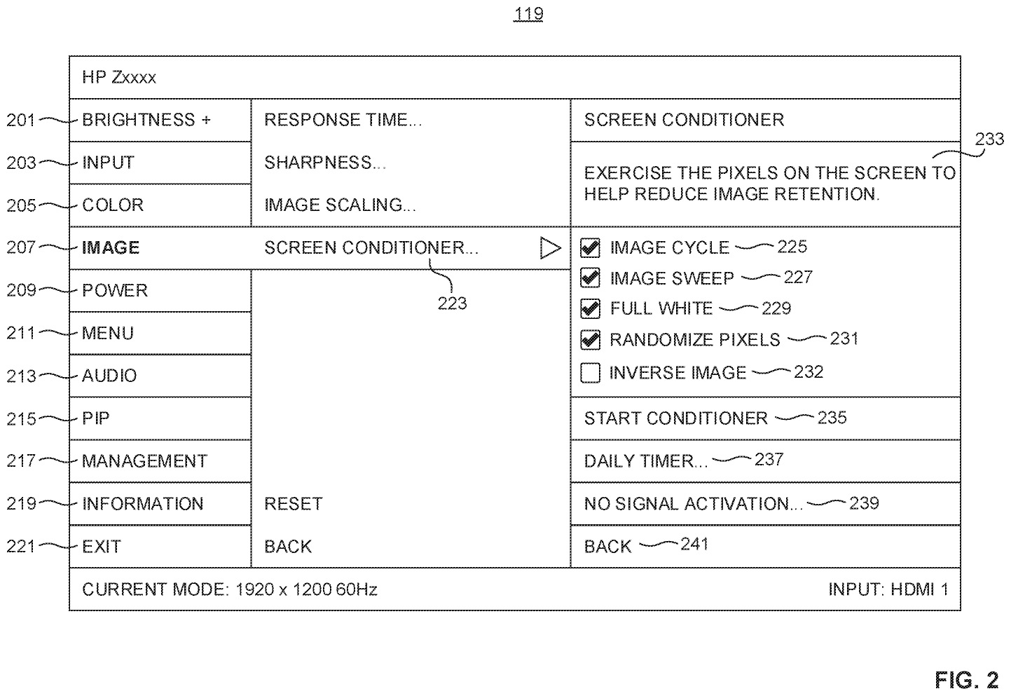

OSD 119 is a graphic that is superimposed on the display screen that can be used to facilitate the input of information that is accessed by the screen conditioner 101 and used to control the function of screen conditioner 101. FIG. 2 shows an example OSD 119. Referring to FIG. 2, OSD 119 includes control options: brightness 201, input 203, color 205, image 207, power 209, menu 211, audio 213, PIP 215, management 217, information 219 and exit 221. Image control option 207 includes screen conditioner controller 223. Screen conditioning options shown in FIG. 2 include image cycle 225, image sweep 227, full white 229, randomize pixels 231, and inverse image 232. Other screen conditioner related controls include controls to exercise the pixels on the screen 233, start conditioner 235, daily timer 237, no signal activation 239 and back 241. In FIG. 2, the screen conditioner control 223 has been selected. Upon selection, the display is expanded to show screen conditioning options. Referring to FIG. 2, options include exercise the pixels on the screen to help reduce image retention 233, image cycle 225, image sweep 227, full white 229, randomize pixels 231, inverse image 232, start conditioner 235, daily timer 237, no signal activation 239 and back. In the FIG. 2 example, the individual system user or the administrator 117 has selected by checkbox image cycle 225, image sweep 227, full white 229 and randomize pixels 231. In response, when prompted, these options will be performed by screen conditioner 101.

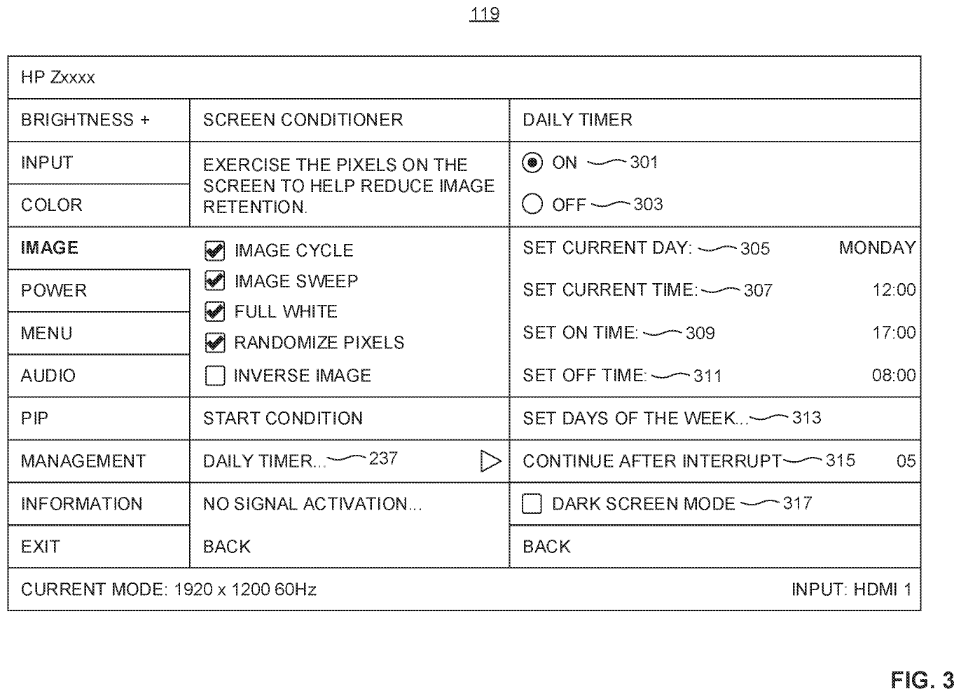

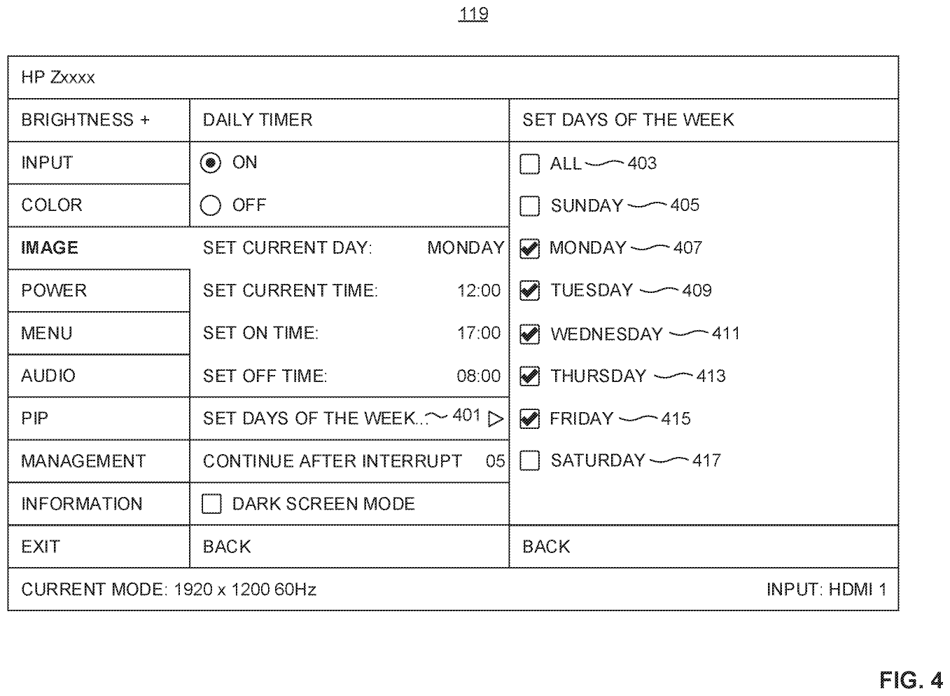

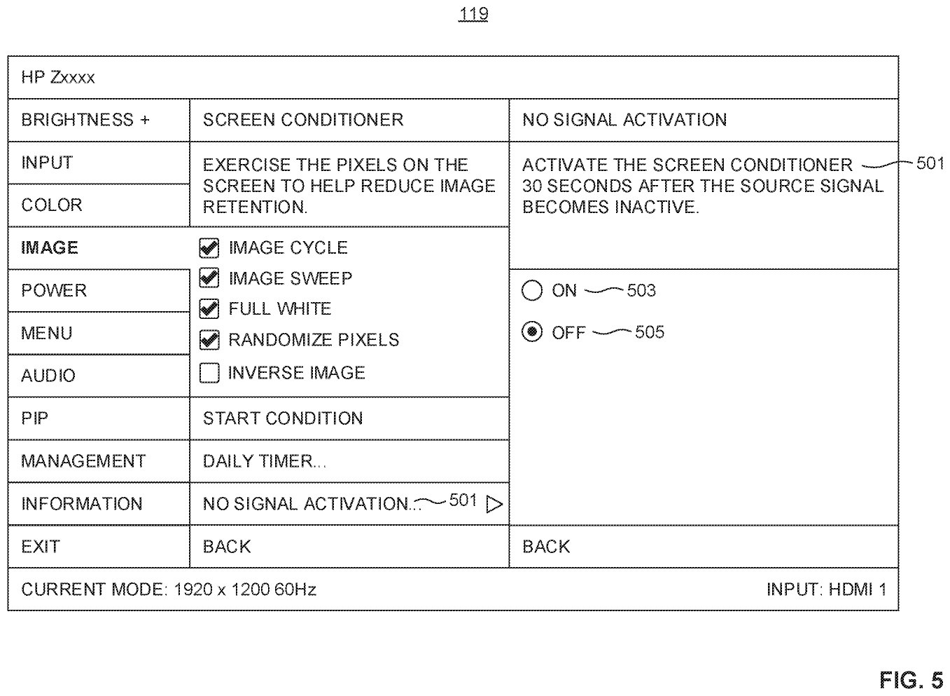

FIG. 3 shows OSD 119 when the daily timer 237 function controller has been selected. The selection of the daily timer 237 function controller expands the OSD 119 to show graphical function controllers ON 301, OFF 303, set current day 305, set current time 307, set on time 309, set off time 311, set days of the week 313, continue after interrupt 315, dark screen mode 317 and back. FIG. 4 shows OSD 119 when the SET DAYS OF THE WEEK 401 function has been selected. The selection of the SET DAYS OF THE WEEK 401 function expands the OSD 119 to show graphical function controllers ALL 403, Sunday 405, Monday 407, Tuesday 409, Wednesday 411, Thursday 413, Friday 415 and Saturday 417. In the FIG. 4 example, function controller check boxes for Monday 407, Tuesday 409, Wednesday 411, Thursday 413, Friday 415 have been checked which prompts conditioner 101 to execute image retention reduction operations on these days. FIG. 5 shows OSD 119 when the NO SIGNAL ACTIVATION 501 function has been selected. The selection of the NO SIGNAL ACTIVATION function 501 expands the OSD 119 to show graphical function controllers ACTIVATE SCREEN CONDITIONER 30 SECONDS AFTER THE SOURCE SIGNAL BECOMES INACTIVE 501, ON 503 and OFF 505. In the FIG. 5 example, the no signal activation function is indicated to be off as the checkbox for function controller OFF 505 has been checked.

Referring again to FIG. 1A, in operation, a user or administrator 117 desiring to execute image retention reduction operations can access screen conditioner 101 via OSD 119. The user or administrator 117 can identify image retention reduction operations that they desire to be executed by the screen conditioner 101 by selecting the screen conditioner function controller 223 (FIG. 2) of OSD 119 and then selecting among the screen conditioning options presented (e.g., 225, 227, 229, 231 and 232 in FIG. 2). The user or administrator 117 can then select the daily timer function controller 237 (FIG. 2) and specify when the screen conditioning options are to be executed over an extended period of time (daily, weekly, etc.). In addition, the user or administrator 117 can set conditions on the execution of screen conditioning options such as directing that screen conditioning is to continue after interrupt and/or that it can be prompted by no signal activation. In some examples, the backlight 121 can illuminate the display 113 from the back of the display panel. In some examples, in dark screen mode, the backlight 121 can be turned off during screen conditioning as is described in detail herein.

In some examples, the OSD 119 menu options allow users to activate multiple built-in, screen conditioners to reduce potential image retention (image burn or sometimes called image sticking) issues. In some examples, the options can be firmware controlled. In other examples, the options can be controlled in other suitable manners. In some examples, the OSD 119 menu offers multiple different methods of reducing image retention. In some examples, the OSD 119 menu can offer a total of five options. In other examples, other numbers of options are offered. In some examples options can include but are not limited to image cycle, image sweep, inverse image, randomized pixels, and full white pattern.

In some examples, the image cycle screen conditioner can cycle through 8 full screen color patterns consecutively every 2 seconds (red, green, blue, black, white, yellow, magenta and cyan). In other examples, the image cycle screen conditioner can cycle through a different number of full screen color patterns consecutively or present the full screen color patterns with another periodicity. In some examples, the image sweep screen conditioner presents full, black and then white, screens consecutively, while multiple black, white or combined black and white bars repeatedly move across the screen horizontally, and then vertically. In some examples, the inverse image option will use the monitor's scaler to auto-detect RGB pixel data and then invert the current pixel colors on the screen. In some examples, the randomize pixel option will randomly scramble pixel data (random white or multi-color noise patterns). In some examples, the full white option will just display a full white screen. In some examples, the screen conditioner options can have checkboxes that allow users to select screen conditioners individually or in combination (e.g., five or more) for consecutive execution as shown in FIGS. 2-6. In some examples, a user can choose to execute a screen conditioner option immediately by selecting the “Start Conditioner” 235 option in the OSD 119 menu. In some examples, a user can stop the conditioning patterns at any time by selecting any of the OSD 119 menu buttons. In some examples, a prompt such as a “Press Any Button to Exit” message can appear on the screen periodically (e.g., every 20 seconds). In some examples, the “Dark Screen Mode” 317 checkbox/option can allow users to run the screen conditioner with the panel backlights turned off, giving an appearance that the screen is off (FIG. 3). This can provide users with a less distracting solution for an office environment and also provides for lower than typical power consumption.

In some examples, the “Daily Timer” 237 option will give users the option to have a screen conditioner turned-on and off at specific times of the day (FIGS. 2-5). For example, a user can have the screen conditioner turned-on at 5 pm in the evening and turned-off automatically at 7 am in the morning. Additional options can include but are not limited to checkboxes for each day of the week for users to select a specific set of days for which to execute the screen conditioner (FIG. 4). Another option termed “Reduce Power” (checkbox) will turn off internal circuitry not needed during the conditioning process. This can include the turning off of an LCD's backlights (see Dark Screen mode 317 in FIGS. 3 and 4). A “Continue After Interrupt” 315 option will allow a user to press a menu button to interrupt an already started timer operation to do more work, and then automatically resume the screen conditioner operation at a user defined time (e.g., 5 min to 60 min or some other length of time) after the interrupt (FIGS. 3 and 4). The “No Signal Activation” 239 feature is an on/off option that allows the screen conditioner to automatically turn on 30 seconds after the monitor detects a “No Signal” condition from the source signal (computer system, etc.) (FIGS. 2 and 3). In some examples, screen conditioner 101 will cycle through the current selected screen conditioner patterns until an active signal is restored. If a timer operation is active, then the “No Signal Activation” 239 option will be disabled (grayed out text) in the OSD menu (FIGS. 2, 3 and 5).

Example advantages include having the option to run screen conditioning patterns while the monitor backlights are off (dark screen). Optionally, the monitor may turn off the power LED, internal USB hub, webcam, and/or other internal devices to lower power consumption during this mode of operation. In some examples, the monitor may turn off other monitor circuitry including speakers, ambient light sensor, USB hubs and the associated devices (e.g., webcam, microphone, touchscreen functions, USB audio, card readers, etc.). In addition, the customizable timer (which can be in one example built into the monitor) allows users to set a daily or weekly schedule when the screen conditioning patterns will operate. User presence is not required. An active signal to the monitor is not required. As part of the timer operation, there will be an option to resume the timer operation after it has been interrupted by the user. The OSD 119 offers users the ability to turn on a real-time signal detection option that initiates screen conditioning patterns whenever the current input signal becomes inactive. Users can select from multiple different screen conditioning methods to help reduce the image retention issues, and they can be executed separately or together, consecutively, to improve the reduction time.

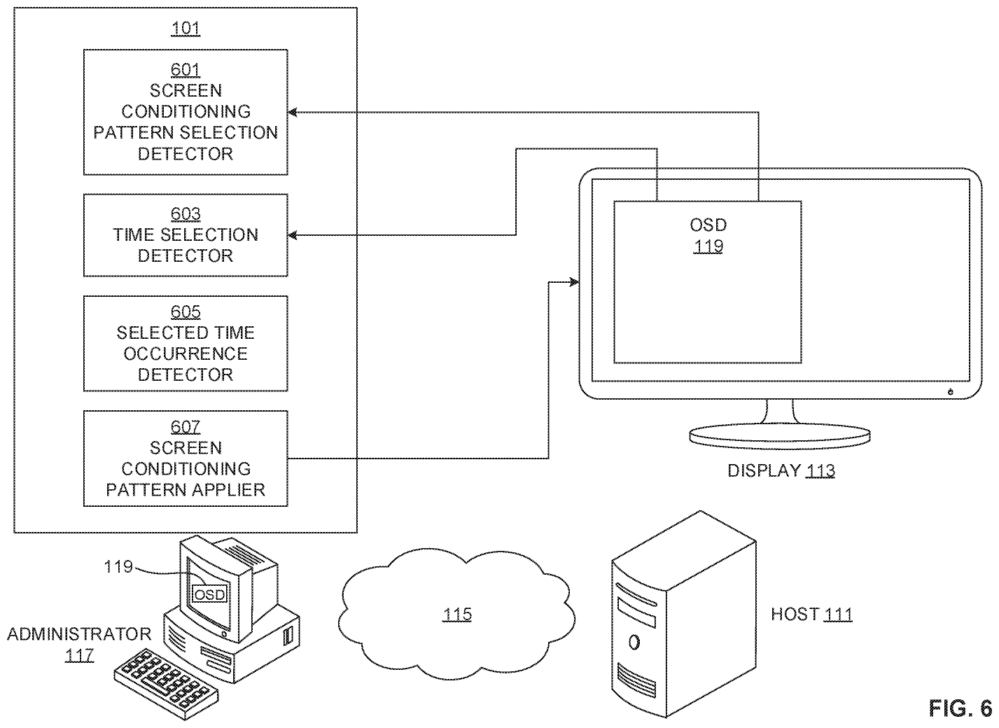

FIG. 6 shows components of screen conditioner 101. FIG. 6 shows screen conditioning pattern selection detector 601, time selection detector 603, selected time occurrence detector 605 and screen conditioning pattern applier 607.

Screen conditioning pattern selection detector 601 determines a screen conditioning pattern that has been selected. The selection is used to access the screen conditioning pattern from the database (e.g., 107 in FIG. 1A).

The time selection detector 603 determines a selection of activation time or times. In some examples, the selection of activation times can be made by a system administrator. In some examples, the selection of activation times can be made by individual users.

The selected time occurrence detector 605 determines when the time that has been selected occurs. For example, if a user selects a time of 2am for activation of a pattern or patterns, when 2am comes, selected time occurrence detector can provide an indication to the screen conditioning pattern applier that the screen conditioning pattern be applied to the screen.

The screen conditioning pattern applier 607 applies at least one screen conditioner to the screen of the display 113. In some examples, screen conditioning pattern applier 607 can access executable instructions that when executed cause screen conditioning patterns to be applied to the screen of the display. In some examples, screen conditioning pattern applier can apply screen conditioning patterns as described in detail herein.

While an example manner of implementing the example screen conditioner 101 of FIG. 1A is illustrated in FIG. 6 the elements, processes and/or devices illustrated in FIG. 2 may be combined, divided, re-arranged, omitted, eliminated and/or implemented in any other way. Further, the example screen conditioning pattern selection detector 601, time selection detector 603, selected time occurrence detector 605 and screen conditioning pattern applier 607 or more generally the example screen conditioner 101 of FIG. 1 may be implemented by hardware, software, firmware and/or any combination of hardware, software and/or firmware. Thus, for example, any of the example, screen conditioning pattern selection detector 601, time selection detector 603, selected time occurrence detector 605 and screen conditioning pattern applier 607 and/or, more generally, the example screen conditioner 101 could be implemented by analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example screen conditioning pattern selection detector 601, time selection detector 603, selected time occurrence detector 605 and screen conditioning pattern applier 607 is/are hereby expressly defined to include a tangible computer readable storage device or storage disk such as a memory, a digital versatile disk (DVD), a compact disk (CD), a Blu-ray disk, etc. storing the software and/or firmware. Further still, the example screen conditioner 101 of FIG. 1 may include elements, processes and/or devices in addition to, or instead of, those illustrated in FIG. 6, and/or may include more than one of any or all of the illustrated elements, processes and devices.

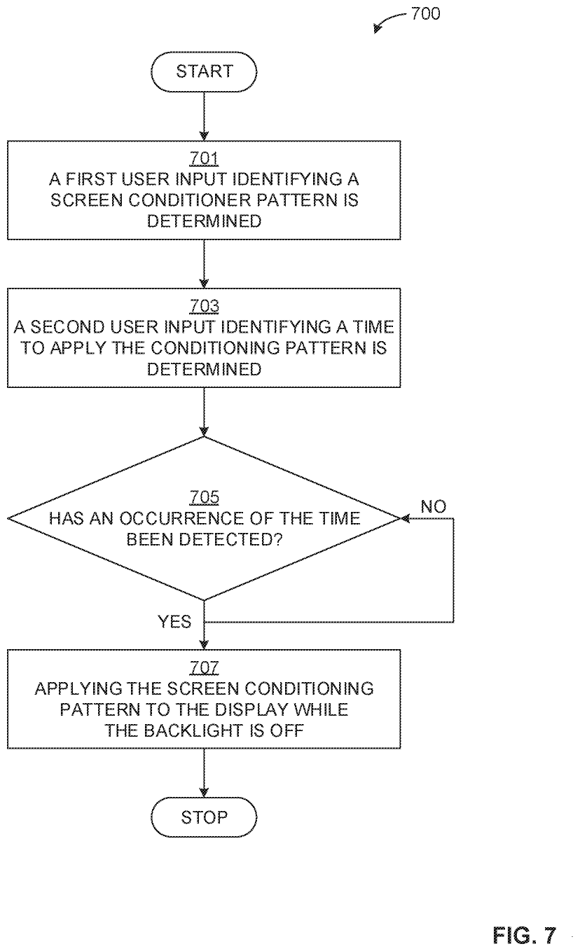

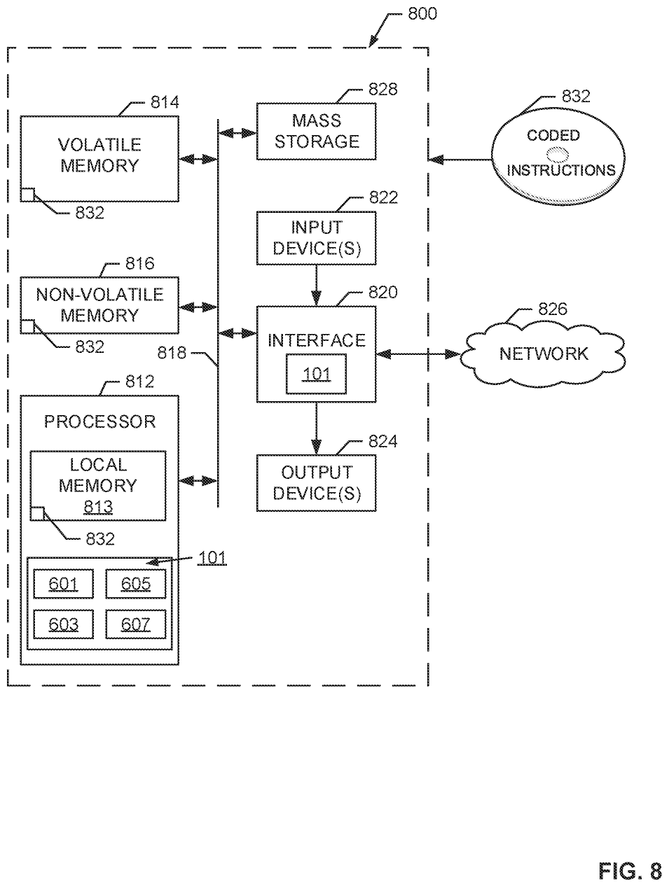

A flowchart representative of example machine readable instructions for implementing the screen conditioner 101 of FIG. 1A is shown in FIG. 7. In this example, the machine readable instructions comprise a program for execution by a processor such as the processor 812 shown in the example processor platform 800 discussed below in connection with FIG. 8. The program may be embodied in software stored on a tangible computer readable storage medium such as a CD-ROM, a floppy disk, a hard drive, a digital versatile disk (DVD), a Blu-ray disk, or a memory associated with the processor 812, but the entire program and/or parts thereof could alternatively be executed by a device other than the processor 812 and/or embodied in firmware or dedicated hardware. Further, although the example program is described with reference to the flowchart illustrated in FIG. 7, many other methods of implementing the example screen conditioner 101 may alternatively be used. For example, the order of execution of the blocks may be changed, and/or some of the blocks described may be changed, eliminated, or combined.

As mentioned above, the example processes of FIG. 7 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIG. 7 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

Referring to FIG. 7, screen conditioning pattern selection detector 601 determines a screen conditioning pattern that has been selected (block 701). The selection is used to access the screen conditioning pattern from the database.

The time selection detector 603 determines a selection of activation time or times (block 703). In some examples, the selection of activation times can be made by a system administrator. In some examples, the selection of activation times can be made by individual users.

The selected time occurrence detector 605 determines when the time that has been selected occurs (block 705). If it is determined that there has not been an occurrence of the time control goes to block 705. If it is determined that there has been an occurrence of the time control goes to block 707.

The screen conditioning pattern applier 607 applies at least one screen conditioner to the screen of the display 113 (block 707). In some examples, screen conditioning pattern applier 207 can access executable instructions that when executed cause screen conditioning patterns to be applied to the screen of the display.

FIG. 8 is a block diagram of an example processor platform 800 capable of being used to implement the screen conditioner 101 of FIG. 1A. The processor platform 800 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 800 of the illustrated example includes a processor 812. The processor 812 of the illustrated example is hardware. For example, the processor 812 can be implemented by integrated circuits, logic circuits, microprocessors or controllers from any desired family or manufacturer.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), and/or a PCI express interface.

In the illustrated example, input devices 822 are connected to the interface circuit 820. The input device(s) 822 permit(s) a user to enter data and commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

Output devices 824 are also connected to the interface circuit 820 of the illustrated example. The output devices 824 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 820 of the illustrated example, thus, can include a graphics driver card, a graphics driver chip or a graphics driver processor.

The interface circuit 820 of the illustrated example also includes a communication device such as a transmitter, a receiver, a transceiver, a modem and/or network interface card to facilitate exchange of data with external machines (e.g., computing devices of any kind) via a network 826 (e.g., an Ethernet connection, a digital subscriber line (DSL), a telephone line, coaxial cable, a cellular telephone system, etc.).

The processor platform 800 of the illustrated example also includes mass storage devices 828 for storing software and/or data. Examples of such mass storage devices 828 include floppy disk drives, hard drive disks, compact disk drives, Blu-ray disk drives, RAID systems, and digital versatile disk (DVD) drives.

The coded instructions 832 of FIG. 8 may be stored in the mass storage device 828, in the volatile memory 814, in the non-volatile memory 816, and/or on a removable tangible computer readable storage medium such as a CD or DVD.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this tent.

What is claimed is:

1. A system to reduce image retention in a display, the system comprising:
a pattern selection detector to detect, with a processor of the display, a first user input identifying a screen conditioning pattern;
a time selection detector to detect, with the processor of the display, a second user input identifying a time to apply the screen conditioning pattern;
a selected time occurrence detector to detect, with the processor, an occurrence of the time; and
a pattern applier to, in response to the detection of the time, apply, with the processor, the screen conditioning pattern to the display while a backlight of the display is off.

2. The system of claim 1, wherein the first user input and the second user input are received via a network communication from remote management.

3. The system of claim 1, wherein the pattern applier applies the screen conditioning pattern to the display while internal circuitry is turned off.

4. The system of claim 1, wherein the pattern applier to auto-detect RGB pixel data and then invert current pixel colors on the display when applying of the screen conditioning pattern to the display.

5. The system of claim 1, wherein the pattern applier to apply the screen conditioning pattern to the display in response to receiving screen conditioning activation times that cover a plurality of days.

6. The system of claim 1, wherein after an interruption of a screen conditioning pattern that is in progress, the screen conditioning pattern is automatically resumed at a time specified in received data.

7. A display comprising:
a screen;
a backlight to illuminate the screen; and
an image retention reducer including a driver to apply an image retention reduction pattern to the screen while the backlight is deactivated.

8. The display of claim 7, wherein the driver applies the image retention reduction pattern to the display while internal circuitry is turned off.

9. The display of claim 7, wherein the driver applying the image retention reduction pattern to the display includes auto-detecting RGB pixel data and then inverting current pixel colors on the display.

10. The display of claim 7, wherein the driver applying the image retention reduction pattern to the display is responsive to a receipt of screen conditioning activation times that cover a plurality of days.

11. The display of claim 7, wherein the driver, after interrupting a screen conditioning pattern that is in progress, resumes the screen conditioning pattern automatically at a time specified in received data.

12. A display comprising:
a screen including a plurality of pixels;
a scaler to detect pixel color respectively retained in corresponding ones of the pixels; and
a driver to activate the pixels to display colors opposite to the corresponding color retained in the respective pixels.

13. The display of claim 12, wherein the driver applies the image retention reduction pattern to the display while internal circuitry is turned off.

14. The display of claim 12, wherein the driver applies the image retention reduction pattern to the display responsive to a receipt of screen conditioning activation times that cover a plurality of days.

15. The display of claim 12, wherein the driver applies the screen conditioning pattern to the display while a backlight of the display is off.
